(19) United States
(12) Patent Application Publication
(10) Pub. No.: US 2007/0253140 A1
(43) Pub. Date: Nov. 1, 2007

(54) Base metal electrode multilayer capacitor with localized oxidizing source

(76) Inventors: Michael S. Randall, Simpsonville, SC (US); Ian Burn, Hockessin, DE (US); Daniel Barber, Greenville, SC (US); Aiying Wang, Simpsonville, SC (US); James Beeson, Simpsonville, SC (US); Pascal Pinceloup, Simpsonville, SC (US); Abhijit Gurav, Greenville, SC (US); Tom Poole, Duncan, SC (US); Azizuddin Tajuddin, Laurens, SC (US)

Correspondence Address: NEXSEN PRUET, LLC, P.O. BOX 10648, GREENVILLE, SC, 29603, US

(21) Appl. No.: 11/413,863

(22) Filed: Apr. 28, 2006

(51) Int. Cl. H01G 5/019

(52) U.S. Cl. 361/300

(57) ABSTRACT

A ceramic capacitor is disclosed. The capacitor comprises a plurality of base metal inner electrode layers, a plurality of ceramic dielectric layers between the inner electrode layers, and external electrodes in electrical conductivity with the inner electrode layers. At least one secondary component having an intentionally added chemistry is dispersed in the inner electrode layers and/or the dielectric layers. The chemistry evolves an oxidizing species in a controlled manner, such that it offsets localized highly reducing atmospheres that are present when the capacitor is fired in a reducing atmosphere, thereby promoting enhanced electrode connectivity in thin layer base metal multilayer capacitors.

### BACKGROUND OF THE INVENTION

The present invention relates to a base metal electrode multilayer ceramic capacitor having continuous electrodes. More particularly, the present invention relates to a base metal electrode multilayer ceramic capacitor and a method of forming the capacitor having fine powder dispersed in the dielectric slurry, the electrode ink or both which evolves an oxidizing species in a controlled manner, to offset localized highly reducing atmospheres present when the capacitor is fired in a reducing atmosphere which may cause electrode discontinuity in the capacitor monolith.

Ceramic capacitors are known to comprise alternating layers of inner electrodes and ceramic dielectric. There has been, and continues to be, a desire to lower the cost and to decrease the size of ceramic capacitors or increase the amount of capacitance per unit volume without sacrificing performance. These desires are often at odds, because typically when the microelectronic devices get smaller and become less expensive, the quality of the devices also decreases. This has led those of skill in the art towards continual efforts to advance the art of capacitors and the manufacture thereof.

Often, the electrodes include the use of base metals such as nickel or copper as the internal electrode material. Base metals have the advantage in that the cost is low compared to noble metals, such as silver and palladium, and the resistance properties are suitable for use in a capacitor. One disadvantage of base metals is the propensity to oxidize under those conditions required to sinter the ceramic dielectric. These problems associated with oxidation have been mitigated by sintering the capacitor in a reducing atmosphere thereby insuring that the metal remains in the metallic state.

Unfortunately, when base metal electrode multilayer ceramic capacitors are fired in a reducing atmosphere, oxygen and hydrogen transport, including the removal of organic binder material, is hampered by the multilayer capacitor monolith. Localized residual or other operant phenomena result in localized atmosphere reduction, causing micro-regions and/or nano-regions of very low partial pressure of oxygen within the immediate area of the base metal electrodes. These localized areas of highly reducing atmosphere result in electrode discontinuity as the electrodes have the tendency to “ball-up” at sintering temperatures when the oxygen partial pressure is very low. By balling up, the metal minimizes the surface energy relative to dielectric interface. This effect results in increased discontinuity of the electrode system. In other words, as the partial pressure of oxygen in the firing atmosphere is reduced, the discontinuity of the electrodes increases. These discontinuous regions make it very difficult, if not impossible to achieve thin electrodes (<˜1.5 um) in thin layer, high active design capacitors.

Increased discontinuity of the internal electrode layers has thwarted the desire for smaller and less expensive ceramic capacitors with higher capacitance per unit volume utilizing base metals. There is an ongoing need for a capacitor and method for reducing or eliminating the micro-regions and/or the nano-regions of very low partial pressure of oxygen in the area of the base metal electrodes within a multilayer capacitor.

U.S. Pat. No. 6,964,718 discloses a method of preparing a multilayer piezoelectric ceramic material and a method for reducing residual carbon caused by the organic binder material. The method includes first applying a base metal powder, which has particles coated with material capable of protecting the base metals from oxidation to a piezoelectric ceramic material. Next, the base metal powder and piezoelectric ceramic material are stacked to produce a multilayer structure and heated at a temperature less than 600 degrees Celsius to remove organic materials and their decomposition products to a level below 200 ppm. Finally, the structure is sintered in a reducing atmosphere at a temperature between 600 degrees Celsius and 1050 degrees Celsius at a partial pressure of oxygen from about 10⁻³ to 10⁻¹⁸ atm.

U.S. Pat. No. 5,503,787 discloses a method for manufacturing multilayer ceramic substrates. Multiple firing steps are used for binder removal including firing in an oxidizing atmosphere and then firing in a reducing atmosphere. United States Patent Publication 2003/0147194 also provides for multiple firing steps. The first firing is for binder removal at lower temperatures usually in a wet nitrogen gas atmosphere or mixed gas or wet nitrogen and hydrogen atmosphere. The second firing is for sintering the dielectric in atmospheres with varying oxygen partial pressure.

While the above described capacitors and methods may reduce the presence of residual carbon and electrode discontinuity, the success of these methodologies is unacceptably limited for electrodes intended to be less than approximately 1.5 μm in fired thickness.

U.S. Pat. No. 5,841,626 provides a capacitor having a dielectric ceramic composition comprising a dielectric ceramic material, at least one stable oxide, such as nickel oxide, magnesium oxide and silicon oxide. Further, the capacitor comprises inner electrodes formed using base metals. A ceramic additive comprising the same compositional material as that for the ceramic layers and containing a small amount of other stable oxides are added to the inner electrodes, and the capacitor is fired in a reducing atmosphere. This patent does not provide for the reduction of residual carbon in the capacitor monolith but only that the ceramic material can be successfully baked without worsening the capacitor characteristics.

Accordingly, due to the growing need for a low cost and optimal performance base metal electrode multilayer ceramic capacitor, the present invention discloses a base metal electrode multilayer ceramic capacitor and a method for forming the capacitor having a localized source of oxygen which evolves an oxidizing species in a controlled manner during thermal processing conditions. The present invention mitigates the problem of localized reduction of partial oxygen pressure and the electrode discontinuity caused thereby. The present invention is particularly important for use in base metal electrode multilayer ceramic capacitors when the electrode thickness is intended to be less than approximately 1.5 micrometer. This controlled evolution of oxygen during thermal processing is effective in eliminating regions of very low partial pressure of oxygen that cause electrode discontinuity in the capacitor monolith.

### SUMMARY OF THE INVENTION

It is an object of the present invention to provide a capacitor with improved properties.

It is another object of the present invention to provide a base metal electrode multilayer ceramic capacitor having continuous electrodes.

It is yet another object of the present invention to provide a method for forming a base metal electrode multilayer ceramic capacitor having continuous electrodes.

It is another object of the present invention to provide a capacitor which has one or more localized oxygen sources within the ceramic monolith when fired.

A particular feature of the present invention is the ability of the system to evolve an oxidizing species in a controlled localized manner when fired in a reducing atmosphere.

A particular advantage of the present invention is the ability to reduce or eliminate regions of very low partial pressure of oxygen in the ceramic monolith.

Another particular advantage of the present invention is the ability to prevent electrode discontinuity.

These and other advantages, as will be realized, are provided in a ceramic capacitor having a plurality of base metal inner electrode layers, external electrodes in electrical conductivity with the inner electrode layers, and a plurality of dielectric layers between the inner electrode layers wherein the dielectric layers comprise a ceramic main component and at least one secondary component dispersed in the ceramic main component wherein the secondary component contains one or more chemistries, such as a metal peroxide or the like, that evolves an oxidizing species including, but not limited to oxygen, carbon monoxide, carbon dioxide, nitrous oxide, or the like in a controlled manner, when the capacitor is fired in a reducing atmosphere.

Yet another embodiment is provided in a base metal electrode multilayer capacitor. The capacitor has a plurality of inner electrode layers, external electrodes in electrical conductivity with the inner electrode layers, and a plurality of dielectric layers between the inner electrode layers. The inner electrode layers comprise a base metal main component and at least one secondary component dispersed in the base metal main component wherein the secondary component contains one or more chemistries, such as a metal peroxide or the like, that evolves an oxidizing species including, but not limited to oxygen, carbon monoxide, carbon dioxide, nitrous oxide, or the like in a controlled manner, when the capacitor is fired in a reducing atmosphere.

These and other advantages, as will be realized, are provided in a method for forming a ceramic capacitor including forming a plurality of inner electrode layers wherein the inner electrode layers comprise a base metal main component and at least one secondary component dispersed in the base metal main component, forming a plurality of ceramic dielectric layers between the inner electrode layers, firing the ceramic capacitor in a reducing atmosphere between 300° and 1500° Celsius wherein the secondary component comprises one or more chemistries, such as a metal peroxide or the like, that evolves an oxidizing species including, but not limited to oxygen, carbon monoxide, carbon dioxide, nitrous oxide, or the like in a controlled manner, when the capacitor is fired in a reducing atmosphere, and electrically connecting external electrodes with the inner electrode layers.

Yet another method is provided in a base metal electrode multilayer capacitor. The method includes forming a plurality of inner electrode layers wherein the inner electrode layers comprise a base metal, forming a plurality of dielectric layers between the inner electrode layers wherein the dielectric layers comprise a ceramic main component and at least one secondary component dispersed in the ceramic main component, firing the ceramic capacitor in a reducing atmosphere between 300° and 1500° Celsius wherein the secondary component comprises one or more chemistries, such as a metal peroxide or the like, that evolves an oxidizing species including, but not limited to oxygen, carbon monoxide, carbon dioxide, nitrous oxide, or the like in a controlled manner, when the capacitor is fired in a reducing atmosphere, and electrically connecting external electrodes with the inner electrode layers.

### BRIEF DESCRIPTIONS OF THE DRAWINGS

FIG. 1 is a cross-sectional view of a multilayer ceramic capacitor.

### DETAILED DESCRIPTION OF THE INVENTION

The invention will be described with reference to the accompanying drawings forming an integral part of the present disclosure.

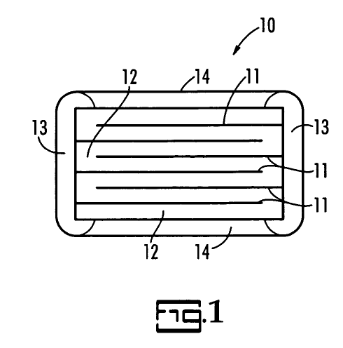

A cross-sectional view of a capacitor of the present invention is illustrated schematically in FIG. 1. In FIG. 1, the capacitor, generally represented at 10, comprises a multiplicity of conductive inner electrodes, 11, with dielectric ceramic layers, 12, dispersed there between. Alternating layers of the conductive layer terminate at opposing external terminals, 13, of opposite polarity. An insulating layer, 14, may be applied.

The dielectric ceramic layers, 12, comprise a dielectric ceramic composition. The major constituent material for the ceramic, for example, may be made of BaTiO₃, BaCaTiZrO₃, BaCaZrO₃, and/or BaZrO₃ but the current invention is not particularly limiting to the type of ceramic dielectric material used and other dielectric materials, insulators, magnetic materials and semiconductor materials or combinations thereof as known in the art. The dielectric ceramic composition is most preferably a non-reducible ceramic which can be sintered in a reducing atmosphere below the melting temperature of common base metals such as nickel and without detriment to the electrode thereby yielding a capacitor with high electrode continuity and excellent electrical properties.

The conductive inner electrodes, 11, comprise a base metal. Common base metals include nickel, tungsten, molybdenum, aluminum, chromium, copper or an alloy thereof which can be fired in a reducing atmosphere. Most preferably the base metal is nickel.

At least one secondary component is dispersed in the dielectric ceramic composition and/or in the conductive inner electrode. The secondary component comprises one or more chemistries, such as a metal peroxide or the like, that evolves oxygen or an oxidizing species including, but not limited to oxygen, carbon monoxide, carbon dioxide, nitrous oxide, or the like in a controlled manner, when the capacitor is fired between approximately 300° and 1500° Celsius in a reducing atmosphere. The particle diameter of the secondary component is usually at least 20 nanometers to no more than 5000 nanometers. The secondary component is dispersed in the dielectric ceramic composition typically while it is in slurry/slip form. Similarly, the secondary component is dispersed in the conductive inner electrode ink prior to forming the capacitor.

Common secondary components include, but are not limited to, at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, vanadium oxide (VO₂, V₂O₃), palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, polonium oxide (PoO₃, PoO₂), silicon (IV) oxide, tellurium oxide (TeO₃, TeO₂), astatine oxide (At₂O₇, At₂O₅, At₂O₃), palladium nitrate, platinum nitrate, platinum nitrate, gold nitrate, molybdenum nitrate, tungsten oxide (WO₃, W₂O₅, WO₂, W₂O₃), molybdenum oxide (MoO₃, Mo₂O₅, MoO₂, Mo₂O₃), chromium oxide (CrO₃, Cr₂O₃), rhenium oxide (Re₂O₇, ReO₃,ReO₂), ruthenium oxide (RuO₄, RuO₃, RuO₂, Ru₂O₃), rhenium oxide (RhO₂, Rh₂O₃), tungsten nitrate, titanium nitrate, zirconium nitrate, the higher valence states of praseodymium oxide (PrO₂), protactinium oxide (Pa₂O₅), uranium oxide (UO₃, U₂O₅, UO₂), samarium oxide (Sm₂O₃), europium oxide (Eu2O3), terbium oxide (TbO₂), thulium oxide, (Tm₂O₃), and ytterbium oxide (Yb₂O₃).

More preferably the secondary components include at least one compound selected from barium peroxide, strontium peroxide, calcium peroxide, molybdenum peroxide, tungsten peroxide, lanthanum peroxide, niobium peroxide, manganese carbonate, manganese (IV) oxide, and manganese (III) oxide.

Most preferably the secondary components include at least one compound selected from barium peroxide, strontium peroxide, calcium peroxide, molybdenum peroxide, manganese carbonate, manganese (IV) oxide, and manganese (III) oxide.

At least 0.015 wt % of a secondary component may be added to the dielectric ceramic composition. Further, no more than 7.5 wt % of secondary component is usually added to the dielectric ceramic composition. At least 0.015 wt % of secondary component may be added to the conductive inner electrode ink. Further, no more than 7.5 wt % of secondary component is usually added to the conductive inner electrode ink.

The composition of the external end terminations, 13, is not particularly limiting herein and any composition typically employed in the art is sufficient. Silver, palladium, copper, nickel or alloys of these metals blended with various glass frits are particularly relevant. A plating layer or multiple plating layers can be formed on the external end terminations.

Because of the use of base metals in the conductive inner electrodes, the capacitor of the present invention is fired in a reducing atmosphere. The reducing overall atmosphere average PO₂ is generally between 10⁻³ to 10⁻¹⁸ atm, while the PO₂ in localized regions within the capacitor monolith have been estimated to be as low as ˜10⁻²⁸ atm (C.A. Randall, et al., “A Structure-Property-Processing Approach Targeted to the Challenges in Capacitive Ceramic Devices,” CARTS USA 2006 PROCEEDINGS, at 3-12, Apr. 3-6, 2006). In traditional capacitors, the reducing atmosphere during firing is very low in oxygen. This concentration of oxygen within the capacitor monolith is further reduced by the oxidation of the residual carbon within the capacitor structure. Since the residual carbon is typically localized to a micro or nano scale, a localized reduction in PO₂ occurs, resulting in PO₂ values as low as 10⁻²⁸ atm. This localized highly reducing atmosphere results in a pristine metal surface at the dielectric-to-electrode interface which increases the free energy of the interface. The electrodes ball up and become discontinuous in order to minimize the free energy of the system. The reduction in free energy per unit volume achieved during this process increases as the electrode thickness is decreased such that this phenomenon is augmented in devices having electrode thickness of less than approximately 1.5 μm. By introducing a controlled, localized source of oxygen in the immediate vicinity of the very low PO₂ regions, the localized PO₂ does not decrease as much and a thin oxide layer is maintained on the base metal electrode surface. This thin oxide reduces the free energy of the dielectric-to-electrode interface, largely eliminating the thermodynamic advantage for the electrode to “ball-up” and to become discontinuous. Further, because of the introduction of a localized source of oxygen, electrode continuity is maintained even when the base metal electrode thickness is reduced below approximately 1.5 μm.

The present invention provides a secondary component that evolves an oxidizing species including, but not limited to oxygen, carbon monoxide, carbon dioxide, nitrous oxide, or the like in a controlled manner, during firing to provide oxidizing capability or atmospheric buffering on a localized micro-scale and/or nano-scale. These multiple oxidation sources combat the effects of residual carbon or other localized reducing agents causing regions of very low partial pressure of oxygen thereby, reducing or eliminating electrode discontinuity found in traditional capacitor monoliths having base metal electrodes of less than approximately 1.5 μm in thickness.

Merely as an example of the manufacturing process of the present invention, a ceramic slurry is prepared by blending and milling the ceramic compounds described herein with a dispersant in either water or an organic solvent such as, for example, ethanol, isopropanol, toluene, ethyl acetate, propyl acetate, butyl acetate or a blend thereof. After milling a ceramic slip is prepared for tape-casting by adding a binder and a plasticizer to control rheology. At least 0.015 wt % but no more than 7.5 wt % of a secondary component which evolves an oxidizing species in a controlled manner between 300° C. and 1500° C. when fired, as discussed above, is dispersed in the ceramic slip. The obtained slip is then processed into a thin sheet by tape-casting. After drying the sheet, a multiplicity of electrodes are patterned on the sheet by using, for example, a screen-printing method to form a printed ceramic sheet.

In an alternative example, a secondary component which evolves an oxidizing species in a controlled manner when fired may also be added to the conductive inner electrode ink prior to patterning on the ceramic sheets. In yet another alternative example, a secondary component which evolves an oxidizing species in a controlled manner when fired is added to the conductive inner electrode ink prior to patterning on the ceramic sheets but is not added to the ceramic slip.

A laminate green body is prepared by stacking onto a substance such as polycarbonate, polyester or a similar method: 1) a certain number of unprinted ceramic sheets representing the bottom covers, then 2) a certain number of printed ceramic sheets in alternate directions so as to create alternating electrodes that terminate at opposing ends, and 3) a certain number of unprinted ceramic sheets representing the top covers. Variations in the stacking order of the printed and unprinted sheets can be used with the dielectric material of this invention. The stack is then pressed at between 20° C. and 120° C. to promote adhesion of all laminated layers. The laminated green body is then cut into individual green chips.

The ceramic is then sintered in a reductive atmosphere with an oxygen partial pressure of 10⁻³ to 10⁻¹⁸ atm at a temperature not to exceed approximately 1500° C.

The sintered capacitor is subjected to end surface grinding by barrel or sand blast, as known in the art, followed by transferring outer electrode paste to form the external electrodes. Further baking is then done to complete the formation of the outer electrodes. The further baking is typically done in a nitrogen atmosphere at a temperature of about 600° C. to 1000° C. for about 0.1 to 1 hour.

Layers of nickel and tin may then be plated on the outer electrodes to enhance solderability and prevent oxidation of the outer electrodes.

If barium peroxide is used as the secondary component, the oxygen would likely evolve in the temperature range between approximately 800° C. and 1100° C. The reaction would be:
BaO₂→BaO+½O₂
Since the amount of residual carbon in the multilayer ceramic capacitor rarely exceeds 10,000 ppm at these temperatures during the firing process, the amount of barium peroxide needed for the oxidation of the residual carbon would be approximately 0.14 wt % and 0.28 wt % respectively to enable the reactions:
C→CO
C→CO₂

From the above reactions, the extra oxygen evolved from the heating of the barium peroxide is collected by the carbon to create either carbon monoxide or carbon dioxide. Therefore, extra oxygen is available for oxidation of the residual carbon in the electrode and dielectric portion of the capacitor, effectively reducing and/or eliminating nano-regions of very low partial pressure of oxygen within the local areas of the base metal electrodes. The carbon to carbon monoxide reaction is likely preferred because of the high temperatures and low partial pressure of oxygen in the reducing firing atmosphere.

The invention has been described with particular reference to the preferred embodiments without limit thereto. Other embodiments and alterations could be realized by one of skill in the art without departing from the invention which is more specifically set forth in the claims appended hereto.

1. A ceramic capacitor comprising:
a plurality of inner electrode layers wherein said inner electrode layers comprise a base metal;
a plurality of dielectric layers between said inner electrode layers wherein said dielectric layers comprise a ceramic main component and at least one secondary component dispersed in said ceramic main component, said secondary component comprises at least one chemistry that evolves an oxidizing species when the capacitor is fired in a reducing atmosphere; and
external electrodes in electrical conductivity with said inner electrode layers.

2. The ceramic capacitor of claim 1 wherein said chemistry evolves an oxidizing species when the capacitor is fired between 300° and 1500° Celsius.

3. The ceramic capacitor of claim 1 comprising at least 0.015 wt % to no more than 7.5 wt % of said secondary component.

4. The ceramic capacitor of claim 1 wherein said secondary component has a particle diameter of at least 20 nm to no more than 5000 nm.

5. The ceramic capacitor of claim 1 wherein said reducing atmosphere comprises between 10⁻³ to 10⁻¹⁸ atm partial pressure of oxygen.

6. The ceramic capacitor of claim 1 wherein said chemistry comprises at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, VO₂, V₂O₃, palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, PoO₃, PoO₂, silicon (IV) oxide, TeO₃, TeO₂, At₂O₇, At₂O₅, At₂O₃, palladium nitrate, platinum nitrate, platinum nitrate, gold nitrate, molybdenum nitrate, WO₃, W₂O₅, WO₂, W₂O₃, MoO₃, Mo₂O₅, MoO₂, Mo₂O₃, CrO₃, Cr₂O₃, Re₂O₇, ReO₃, ReO₂, RuO₄, RuO₃, RuO₂,Ru₂O₃,RhO₂,Rh₂O₃, tungsten nitrate, titanium nitrate, zirconium nitrate, the higher valence states of PrO₂, Pa₂O₅, UO₃, U₂O₅, UO₂, Sm₂O₃, Eu2O3, TbO₂, Tm₂O₃, and Yb₂O₃.

7. The ceramic capacitor of claim 6 wherein said chemistry comprises at least one compound selected from barium peroxide, strontium peroxide, calcium peroxide, molybdenum peroxide, tungsten peroxide, lanthanum peroxide, niobium peroxide, manganese carbonate, manganese (IV) oxide, and manganese (III) oxide.

8. The ceramic capacitor of claim 7 wherein said chemistry comprises at least one compound selected from barium peroxide, strontium peroxide, calcium peroxide, molybdenum peroxide, manganese carbonate, manganese (IV) oxide, and manganese (III) oxide.

9. The ceramic capacitor of claim 1 wherein said main ceramic component comprises at least one compound selected from BaTiO₃, BaCaTiZrO₃, BaCaZrO₃, and BaZrO₃.

10. The ceramic capacitor of claim 1 wherein said inner electrode layers comprise a second secondary component that comprises a second chemistry wherein said second chemistry evolves an oxidizing species when the capacitor is fired in a reducing atmosphere.

11. The ceramic capacitor of claim 1 wherein said oxidizing species comprises a compound selected from oxygen, carbon monoxide, carbon dioxide, and nitrous oxide.

12. A ceramic capacitor comprising:
a plurality of inner electrode layers wherein said inner electrode layers comprise a base metal;
a plurality of dielectric layers between said inner electrode layers wherein said dielectric layers comprise a ceramic main component and at least 0.015 wt % to no more than 7.5 wt % of at least one secondary component dispersed in said ceramic main component, and wherein said secondary component has a particle diameter of at least 20 nm to no more than 5000 nm, said secondary component further comprises at least one chemistry that evolves an oxidizing species selected from oxygen, carbon monoxide, carbon dioxide, and nitrous oxide when the capacitor is fired between 300° and 1500° Celsius in a reducing atmosphere between 10⁻³ to 10⁻¹⁸ atm partial pressure of oxygen; and
external electrodes in electrical conductivity with said inner electrode layers.

13. The ceramic capacitor of claim 12 wherein said chemistry comprises at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, VO₂, V₂O₃, palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, PoO₃, PoO₂, silicon (IV) oxide, TeO₃, TeO₂, At₂O₇, At₂O₅, At₂O₃, palladium nitrate, platinum nitrate, platinum nitrate, gold nitrate, molybdenum nitrate, WO₃, W₂O₅, WO₂, W₂O₃, MoO₃, Mo₂O₅, MoO₂, Mo₂O₃, CrO₃, Cr₂O₃, Re₂O₇, ReO₃, ReO₂, RuO₄, RuO₃, RuO₂, Ru₂O₃, RhO₂, Rh₂O₃, tungsten nitrate, titanium nitrate, zirconium nitrate, the higher valence states of PrO₂, Pa₂O₅, UO₃, U₂O₅, UO₂, Sm₂O₃, Eu2O3, TbO₂, Tm₂O₃, and Yb₂O₃.

14. The ceramic capacitor of claim 13 wherein said chemistry comprises at least one compound selected from barium peroxide, strontium peroxide, calcium peroxide, molybdenum peroxide, tungsten peroxide, lanthanum peroxide, niobium peroxide, manganese carbonate, manganese (IV) oxide, and manganese (III) oxide.

15. The ceramic capacitor of claim 14 wherein said chemistry comprises at least one compound selected from barium peroxide, strontium peroxide, calcium peroxide, molybdenum peroxide, manganese carbonate, manganese (IV) oxide, and manganese (III) oxide.

16. The ceramic capacitor of claim 12 wherein said main ceramic component comprises at least one compound selected from BaTiO₃, BaCaTiZrO₃, BaCaZrO₃, and BaZrO₃.

17. The ceramic capacitor of claim 12 wherein said inner electrode layers comprise a second secondary component that comprises a second chemistry wherein said second chemistry evolves an oxidizing species when the capacitor is fired in a reducing atmosphere.

18. A ceramic capacitor comprising:
a plurality of inner electrode layers wherein said inner electrode layers comprise a base metal main component and at least one secondary component dispersed in said base metal main component, said secondary component comprises at least one chemistry that evolves an oxidizing species when the capacitor is fired in a reducing atmosphere;
a plurality of ceramic dielectric layers between said inner electrode layers; and
external electrodes in electrical conductivity with said inner electrode layers.

19. The ceramic capacitor of claim 18 wherein said chemistry evolves an oxidizing species when the capacitor is fired between 300° and 1500° Celsius.

20. The ceramic capacitor of claim 18 comprising at least 0.015 wt % to no more than 7.5 wt % of said secondary component.

21. The ceramic capacitor of claim 18 wherein said secondary component has a particle diameter of at least 20 nm to no more than 5000 nm.

22. The ceramic capacitor of claim 18 wherein said reducing atmosphere comprises between 10⁻³ to 10⁻¹⁸ atm partial pressure of oxygen.

23. The ceramic capacitor of claim 18 wherein said chemistry comprises at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, VO₂, V₂O₃, palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, PoO₃, PoO₂, silicon (IV) oxide, TeO₃, TeO₂, At₂O₇, At₂O₅, At₂O₃, palladium nitrate, platinum nitrate, platinum nitrate, gold nitrate, molybdenum nitrate, WO₃, W₂O₅, WO₂, W₂O₃, MoO₃, Mo₂O₅, MoO₂, Mo₂O₃, CrO₃, Cr₂O₃, Re₂O₇, ReO₃, ReO₂, RuO₄, RuO₃, Ru O₂, Ru₂O₃, Rho₂, Rh₂O₃, tungsten nitrate, titanium nitrate, zirconium nitrate, the higher valence states of PrO₂, Pa₂O₅, UO₃, U₂O₅, UO₂, Sm₂O₃, Eu2O3, TbO₂, Tm₂O₃, and Yb₂O₃.

24. The ceramic capacitor of claim 23 wherein said chemistry comprises at least one compound selected from barium peroxide, strontium peroxide, calcium peroxide, molybdenum peroxide, tungsten peroxide, lanthanum peroxide, niobium peroxide, manganese carbonate, manganese (IV) oxide, and manganese (III) oxide.

25. The ceramic capacitor of claim 24 wherein said chemistry comprises at least one compound selected from barium peroxide, strontium peroxide, calcium peroxide, molybdenum peroxide, manganese carbonate, manganese (IV) oxide, and manganese (III) oxide.

26. The ceramic capacitor of claim 18 wherein said main ceramic component comprises at least one compound selected from BaTiO₃, BaCaTiZrO₃, BaCaZrO₃, and BaZrO₃.

27. The ceramic capacitor of claim 18 wherein said oxidizing species comprises at least one compound selected from oxygen, carbon monoxide, carbon dioxide, and nitrous oxide.

28. A ceramic capacitor comprising:
a plurality of inner electrode layers wherein said inner electrode layers comprise a base metal main component and at 0.015 wt % to no more than 7.5 wt % of at least one secondary component dispersed in said base metal main component and wherein said secondary component has a particle diameter of at least 20 nm to no more than 5000 nm, said secondary component further comprises at least one chemistry that evolves an oxidizing species selected from oxygen, carbon monoxide, carbon dioxide, and nitrous oxide when the capacitor is fired between 300° and 1500° Celsius in a reducing atmosphere between 10⁻³ to 10⁻¹⁸ atm partial pressure of oxygen;
a plurality of ceramic dielectric layers between said inner electrode layers; and
external electrodes in electrical conductivity with said inner electrode layers.

29. The ceramic capacitor of claim 28 wherein said chemistry comprises at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, VO₂, V₂O₃, palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, PoO₃, PoO₂, silicon (IV) oxide, TeO₃, TeO₂, At₂O₇, At₂O₅, At₂O₃, palladium nitrate, platinum nitrate, platinum nitrate, gold nitrate, molybdenum nitrate, WO₃, W₂O₅, WO₂, W₂O₃, MoO₃, Mo₂O₅, MoO₂, Mo₂O₃, CrO₃, Cr₂O₃, Re₂O₇, ReO₃, ReO₂, RuO₄, RuO₃, Ru O₂, Ru₂O₃, RhO₂, Rh₃, tungsten nitrate, titanium nitrate, zirconium nitrate, the higher valence states of PrO₂, Pa₂O₅, UO₃, U₂O₅, UO₂, Sm₂O₃, Eu2O3, TbO₂, Tm₂O₃, and Yb₂O₃.

30. The ceramic capacitor of claim 29 wherein said chemistry comprises at least one compound selected from barium peroxide, strontium peroxide, calcium peroxide, molybdenum peroxide, tungsten peroxide, lanthanum peroxide, niobium peroxide, manganese carbonate, manganese (IV) oxide, and manganese (III) oxide.

31. The ceramic capacitor of claim 30 wherein said chemistry comprises at least one compound selected from barium peroxide, strontium peroxide, calcium peroxide, molybdenum peroxide, manganese carbonate, manganese (IV) oxide, and manganese (III) oxide.

32. The ceramic capacitor of claim 28 wherein said main ceramic component comprises at least one compound selected from BaTiO₃, BaCaTiZrO₃, BaCaZrO₃, and BaZrO₃.

33. A method for forming a ceramic capacitor comprising:
forming a plurality of inner electrode layers wherein said inner electrode layers comprise a base metal;
forming a plurality of dielectric layers between said inner electrode layers wherein said dielectric layers comprise a ceramic main component and at least one secondary component dispersed in said ceramic main component;
firing said ceramic capacitor in a reducing atmosphere between 300° and 1500° Celsius wherein said secondary component comprises at least one chemistry that evolves an oxidizing species when the capacitor is fired in a reducing atmosphere; and
electrically connecting external electrodes with said inner electrode layers.

34. A capacitor formed by the method of claim 33.

35. The method for forming a ceramic capacitor of claim 33 wherein said ceramic capacitor comprises at least 0.015 wt % to no more than 7.5 wt % of secondary component.

36. The method for forming a ceramic capacitor of claim 33 wherein said secondary component has a particle diameter of at least 20 nm to no more than 5000 nm.

37. The method for forming a ceramic capacitor of claim 33 wherein said reducing atmosphere comprises between 10⁻³ to 10⁻¹⁸ atm partial pressure of oxygen.

38. The method for forming a ceramic capacitor of claim 33 wherein said chemistry comprises at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, VO₂, V₂O₃, palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, PoO₃, PoO₂, silicon (IV) oxide, TeO₃, TeO₂, At₂O₇, At₂O₅, At ₂O₃, palladium nitrate, platinum nitrate, platinum nitrate, gold nitrate, molybdenum nitrate, WO₃, W₂O₅, WO₂, W₂O₃, MoO₃, Mo₂O₅, MoO₂, Mo₂O₃, CrO₃, Cr₂O₃, Re₂O₇,ReO₃, ReO₂, RuO₄, RuO₃, RuO₂, Ru₂O₃, RhO₂, Rh₂O₃, tungsten nitrate, titanium nitrate, zirconium nitrate, the higher valence states of PrO₂, Pa₂O₅, UO₃, U₂O₅, UO₂, Sm₂O₃, Eu2O3, TbO₂, Tm2O₃, and Yb₂O₃.

39. The method for forming a ceramic capacitor of claim 33 wherein said inner electrode layers comprise at least one second secondary component wherein said second secondary component comprises a second chemistry that evolves an oxidizing species when the capacitor is fired in a reducing atmosphere between 300° and 1500° Celsius.

40. The method for forming a ceramic capacitor of claim 33 wherein said oxidizing species comprises a compound selected from oxygen, carbon monoxide, carbon dioxide, and nitrous oxide.

41. A method for forming a ceramic capacitor comprising:
forming a plurality of inner electrode layers wherein said inner electrode layers comprise a base metal main component and at least one secondary component dispersed in said base metal main component;
forming a plurality of ceramic dielectric layers between said inner electrode layers;
firing said ceramic capacitor in a reducing atmosphere between 300° and 1500° Celsius wherein said secondary component comprises at least one chemistry that evolves an oxidizing species when the capacitor is fired in a reducing atmosphere; and
electrically connecting external electrodes with said inner electrode layers.

42. A capacitor formed by the method of claim 41.

43. The method for forming a ceramic capacitor of claim 41 wherein said ceramic capacitor comprises at least 0.015 wt % to no more than 7.5 wt % of secondary component.

44. The method for forming a ceramic capacitor of claim 41 wherein said secondary component has a particle diameter of at least 20 nm to no more than 5000 nm.

45. The method for forming a ceramic capacitor of claim 41 wherein said reducing atmosphere comprises between 10⁻³ to 10⁻¹⁸ atm partial pressure of oxygen.

46. The ceramic capacitor of claim 41 wherein said chemistry comprises at least one compound selected from nickel oxide, nickel peroxide, barium peroxide, strontium peroxide, calcium peroxide, molybdenum peroxide, tungsten peroxide, lanthanum peroxide, niobium peroxide, cobalt oxide, cobalt peroxide, cobalt trioxide, cobalt susquioxide, cerium peroxide, ruthenium peroxide, osmium peroxide, vanadium pentoxide, VO₂, V₂O₃, palladium (II) oxide, tenorite, cuprite, magnesium peroxide, lithium peroxide, zirconium peroxide, titanium peroxide, ammonium nitrate, barium nitrate, strontium nitrate, calcium nitrate, magnesium nitrate, lithium nitrate, cerium nitrate, yttrium nitrate, cesium nitrate, dysprosium nitrate, holmium nitrate, erbium nitrate, manganese nitrate, manganese carbonate, manganese (VII) oxide, manganese (VI) oxide, manganese (IV) oxide, manganese (III) oxide, iron (III) oxide, cobalt nitrate, nickel nitrate, nickel (III) oxide, copper (II) oxide, niobium (V) oxide, palladium (IV) oxide, platinum (IV) oxide, gold (III) oxide, tin (IV) oxide, antimony (V) oxide, mercury (II) oxide, thallium (III) oxide, lead (IV) oxide, bismuth (V) oxide, PoO₃, PoO₂, silicon (IV) oxide, TeO₃, TeO₂, At₂O₇, At₂O₅, At₂O₃, palladium nitrate, platinum nitrate, platinum nitrate, gold nitrate, molybdenum nitrate, WO₃, W₂O₅, WO₂, W₂O₃, MoO₃, Mo₂O₅, MoO₂, Mo₂O₃, CrO₃, Cr₂O₃, Re₂O₇, ReO₃, ReO₂, RuO₄, RuO₃, Ru O₂, Ru₂O₃, RhO₂, Rh₂O₃, tungsten nitrate, titanium nitrate, zirconium nitrate, the higher valence states of PrO₂, Pa₂O₅, UO₃, U₂O₅, UO₂, Sm₂O₃, Eu2O3, TbO₂, Tm₂O₃, and Yb₂O₃.

47. The method for forming a ceramic capacitor of claim 41 wherein said oxidizing species comprises a compound selected from oxygen, carbon monoxide, carbon dioxide, and nitrous oxide.
